(19) United States
(12) Patent Application Publication
(10) Pub. No.: US 2012/0101996 A1
(43) Pub. Date: Apr. 26, 2012

(54) APPARATUS AND METHOD FOR SNAPSHOT IMAGE SEGMENTATION

(76) Inventors: Geun-Sik Lim, Hwaseong-si (KR); Myung-June Jung, Suwon-si (KR); Sang-Bum Suh, Seoul (KR); Sung-Min Lee, Suwon-si (KR)

(21) Appl. No.: 13/105,007

(22) Filed: May 11, 2011

(30) Foreign Application Priority Data
Oct. 21, 2010 (KR) 10-2010-0103096

(51) Int. Cl. G06F 17/30

(52) U.S. Cl. 707/649; 707/E17.01

(57) ABSTRACT

Provided are an apparatus to restore data, and a snapshot image segmentation apparatus and method that create a plurality of snapshot images, store the snapshot images in a storage, and load the stored snapshot images to a memory according to snapshot image loading priority. The snapshot image segmentation apparatus may includes a number-of-snapshot images deciding unit configured to decide the number of snapshot images, a segmentation unit configured to segment an entire image including data stored in a memory into one or more snapshot images, based on the number of snapshot images, and a loading priority deciding unit configured to decide snapshot image loading priority of the segmented snapshot images, based on data loading priority of the data stored in the memory.

### CROSS-REFERENCE TO RELATED APPLICATION

This application claims the benefit under 35 U.S.C. §119(a) of a Korean Patent Application No. 10-2010-0103096, filed on Oct. 21, 2010, the entire disclosure of which is incorporated herein by reference for all purposes.

### BACKGROUND

1. Field

The following description relates to a technique for creating a snapshot image including data stored in a memory at a specific time, storing the snapshot image in a storage, and loading, in response to a data restoration signal being received, the snapshot image stored in the storage to restore the data.

2. Description of the Related Art

In times, a user may decide to format a storage and reinstall the programs installed in the storage. For example, the user may format the storage because execution speed of a program may have dropped considerably, or errors are generated often due to a virus infection. However, the task of formatting the storage and reinstalling the programs requires a relatively long time, which is inconvenient to the user. In order to reduce the task time, a technique may be utilized where files or data stored in the storage are backed up when the system is in a normal operating state, and restoring the files or data based on the backed up data.

Recently, a snapshot function has been used to restore data. For example, a snapshot image processor, which implements a snapshot function, creates, in response to receiving a signal for executing the snapshot function, snapshot images including data stored in a memory and stores the snapshot images in a storage. Thereafter, in response to receiving a signal for restoring data, the snapshot image processor loads the snapshot images stored in the storage to the memory to thereby restore data. Accordingly, a user may use the snapshot function to more efficiently restore data used at a predetermined time, for example, at the time at which a signal for executing the snapshot function is received. However, when the size of the snapshot images is relatively large and/or data input/output speed is slow, a considerable time may be consumed to load the snapshot images and restore the data.

### SUMMARY

In one general aspect, there is provided a snapshot image segmentation apparatus including a number-of-snapshot images deciding unit configured to decide the number of snapshot images, a segmentation unit configured to segment an entire image including data stored in a memory into one or more snapshot images, based on the number of snapshot images, and a loading priority deciding unit configured to decide snapshot image loading priority of the segmented snapshot images, based on data loading priority of the data stored in the memory.

The snapshot image segmentation apparatus may further include a storing/loading controller configured to store the segmented snapshot images in a storage.

The snapshot image segmentation apparatus may further include a storing/loading controller configured to load the segmented snapshot images stored in a storage to the memory, based on the snapshot image loading priority.

The loading priority deciding unit may decide the data loading priority based on a booting sequence, frequency of pagefault occurrence, a memory set size, or a combination thereof.

The number-of-snapshot images deciding unit may decide the number of snapshot images based on a size of the entire image stored in the memory, a data input/output speed, and a target booting time.

The data input/output speed may be speed at which data is input/output between a storage and the memory.

The segmentation unit may segment the entire image based on source (SRC) addresses and information about a data size.

The snapshot image segmentation apparatus may further include a deletion unit configured to delete data that is not subject of restoration, among the data stored in the memory.

In another general aspect, there is provided a snapshot image segmentation method, the method including deciding the number of snapshot images, segmenting an entire image including data stored in a memory into one or more snapshot images, based on the number of snapshot images, and deciding snapshot image loading priority of the segmented snapshot images, based on data loading priority of the data stored in the memory.

The method may further include storing the segmented snapshot images in a storage.

The method may further include loading the segmented snapshot images stored in a storage to the memory, based on the snapshot image loading priority.

The deciding of the snapshot image loading priority may include deciding the data loading priority based on a booting sequence, frequency of pagefault occurrence, a memory set size, or a combination thereof.

The deciding of the number of snapshot images may include deciding the number of snapshot images based on a size of the entire image stored in the memory, a data input/output speed, and a target booting time.

The data input/output speed may be speed at which data is input/output between a storage and the memory.

The segmenting of the entire image may include segmenting the entire image based on source (SRC) addresses and information about a data size.

The method may further include deleting data that is not subject of restoration, among the data stored in the memory.

In still another general aspect, there is provided an apparatus to restore data using a snapshot function, the apparatus including a snapshot image processor configured to create snapshot images from an entire image based on a predetermined number, and load the snapshot images based on data loading priority of data stored in a memory.

The snapshot image processor may include a segmentation unit configured to segment the entire image into the snapshot images, based on the predetermined number having a relationship to a size of the entire image, a data input/output speed, a target booting time, or a combination thereof, and a storing/loading controller configured to load the snapshot images to the memory based on predetermined time intervals.

The snapshot image processor may create a snapshot image having a predetermined size that is based on a data input/output speed and restore the data in a unit corresponding to the predetermined size of the snapshot image.

The data loading priority may be based on a booting sequence, frequency of pagefualt occurrence, a memory set size, or a combination thereof.

Other features and aspects will be apparent from the following detailed description, the drawings, and the claims.

### BRIEF DESCRIPTION OF THE DRAWINGS

FIG. 1 is a diagram illustrating an example of a snapshot image segmentation apparatus.

FIG. 2 is a diagram for explaining an example of a method in which data and an image are stored in a memory and storage.

FIG. 3 is a diagram for explaining another example of a method in which data and an image are stored in a memory and storage.

FIG. 4 is a diagram for explaining an example of a method of loading snapshot images stored in a storage to a memory.

FIG. 5 is a flowchart illustrating an example of a snapshot image segmentation method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

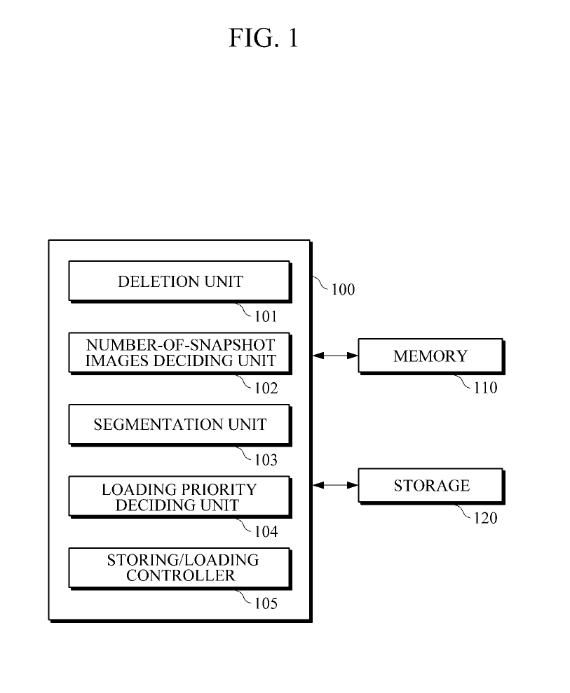

FIG. 1 shows an example of a snapshot image segmentation apparatus 100.

Referring to FIG. 1, the snapshot image segmentation apparatus 100 includes a deletion unit 101, a number-of-snapshot images deciding unit 102, a segmentation unit 103, a loading priority deciding unit 104, and a storing/loading controller 105. For the illustrative purpose, without limiting thereto, in the descriptions herein, an “image” may be a dump file or a group composed of a plurality of pieces of data.

In FIG. 1, a memory 110 is a memory that, for example, a central processing unit (CPU) uses to execute a program. The memory 110 may be a random access memory (RAM) or a read only memory (ROM) and may be assigned a physical address. The memory 110 may also be referred to as a physical memory.

A storage 120 is, for example, a storage area to store programs. The storage 120 may be used to store programs when the storage capacity of the memory 110 is insufficient. The storage 120 may be, for example, a hard disk or a flash memory. A part of the storage 120 may be used as a storage area for storing programs. The part of the storage 120 used to store the programs may also be referred to as a virtual memory. The storage 120 may be assigned a virtual address. In the example illustrated in FIG. 1, the configuration may further include a memory management unit (MMU) (not shown) that manages the access of CPU to the memory 110. The MMU may convert addresses of the storage 120 to addresses of the memory 110, and perform memory protection, cache management, bus arbitration, and the like.

Referring to the example of FIG. 1, in response to receiving a signal for executing a snapshot function, the deletion unit 101 deletes data that does not need to be restored or is not subject of restoration. Accordingly, such data may be prevented from being stored in the storage 120. The number-of-snapshot images deciding unit 102 decides the number of snapshot images. For example, the number-of-snapshot images deciding unit 102 may decide the number of snapshot images based on the size of an entire stored image, a data input/output speed, and a target booting time, which may be expressed as Equation 1 below. The entire stored image may refer to a single image including all data stored in the memory 110. The data input/output speed may refer to speed at which data is input/output between the storage 120 and the memory 110.

The Number of Snapshot Images=Size of Entire Image/(Data Input/Output Speed*Target Booting Time) (1)

For example, if the size of the entire image is 450 MB, the data input/output speed is 30 MB/s, and the target booting time is 3 s, the number of snapshot images is calculated as 5. In this case, the size of each snapshot image may be 90 MB (=450 MB/5).

If the number of snapshot images is calculated as a number having a decimal point, the number-of-snapshot images deciding unit 102 may round-up the number. For example, when the number of snapshot images is calculated as 2.1, 2.5, or 2.8, the number-of-snapshot images deciding unit 102 may round-up the calculated number to 3.

The data from the storage 120 may be loaded to the memory 110 in different ways. For example, one method is to load data stored in the storage 120 to the memory 110 through a direct memory access. In this case, data loading is not performed through a CPU. Another method is to load data stored in the storage 120 to the memory 110 using a CPU. In this case, the data input/output speed will depend on an operating speed of the CPU. The operating speed of the CPU may refer to the quantity of data transmittable per second. The current example and teachings herein may be applied to these and other methods.

The segmentation unit 103 segments the entire image including data stored in the memory 110 based on the number of snapshot images decided by the number-of-snapshot images deciding unit 102. For example, if the size of the entire image is 450 MB, the data input/output speed is 30 MB/s, and the target booting time is 3 s, the number of snapshot images is determined as 5. In this case, the size of each snapshot image may be 90 MB. Also in this case, the segmentation unit 103 may segment the entire image into the size of 90 MB to create 5 snapshot images.

The segmentation unit 103 may segment the entire image based on data size information included in a source (SRC) address and offset information. For example, in a case where the size of data assignable to a memory address is 4 KB, the size of the entire data is 36 KB, the entire data is stored in addresses from 0x00000010 to 0x00000018, and the size of a snapshot image is 24 KB, the segmentation unit 103 may create data (24 KB) stored in addresses from 0x00000010 to 0x00000015 as a first snapshot image, and data (12 KB) stored in addresses from 0x00000016 to 0x00000018 as a second snapshot image.

The loading priority deciding unit 104 decides data loading priority of data stored in the memory 110. For example, the data loading priority may refer to the priority order in which data is loaded upon booting. The loading priority deciding unit 104 may decide the data loading priority based on one or more factors such as a booting sequence, the frequency of pagefault occurrence, and a memory set size. The memory set size may be a resident set size (RSS) or a unique set size (USS). For example, if first, second and third data are stored in the memory 110, the loading priority deciding unit 104 may decide data loading priority of the first, second and third data such that the first, second and third data are loaded in the order of: the second data→the third data→the first data. Then, the loading priority deciding unit 104 may decide snapshot image loading priority of snapshot images segmented by the segmentation unit 103, based on the data loading priority. For example, the snapshot image loading priority may refer to the priority order in which snapshot images stored in the storage 120 are loaded to the memory 110 upon booting. The storing/loading controller 105 may load the snapshot images stored in the storage 120 to the memory 110 according to the snapshot image loading priority. The storing/loading controller 105 may store information about the snapshot image loading priority and the snapshot images in the storage 120.

In response to receiving a signal for restoring data, the storing/loading controller 105 may load the snapshot images stored in the storage 120 to the memory 110 according to the snapshot image loading priority. For example, if first, second and third snapshot images are stored in the storage 120, and the snapshot image loading priority is in the priority order of: the second snapshot image→the third snapshot image→the first snapshot image, the storing/loading controller 105 may load the first, second, and third snapshot images to the memory 110 in the order of: the second snapshot image→the third snapshot image→the first snapshot image.

The snapshot image loading priority may be decided in order to more quickly load snapshot images having data initially used upon booting. For example, the storing/loading controller 105 may load an image including operating system (OS), load an image including data needed to display an initial screen, and then load images including the remaining data.

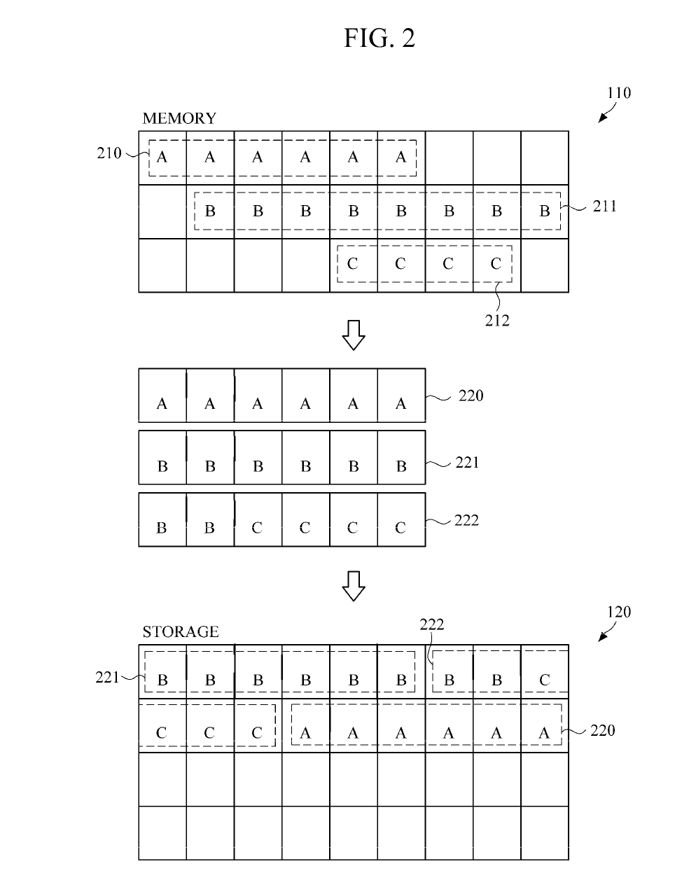

FIG. 2 is an illustration to explain an example of a method in which data and an image are stored in a memory and storage.

Referring to FIGS. 1 and 2, according to an example, it is assumed that a data size assignable to a memory address is 4 KB, and first data 210 having the size of 24 KB, second data 211 having the size of 32 KB, and third data 212 having the size of 16 KB are stored in the memory 110.

In this example, it is further assumed as the case where the number-of-snapshot images deciding unit 102 decides the number of snapshot images to be 3. Accordingly, since the entire size of the first, second and third data 210, 211, and 212 is 72 KB, the size of a snapshot image is determined as 24 KB.

The segmentation unit 103 may segment the entire image based on the number of snapshot images decided by the number-of-snapshot images deciding unit 102, in the order in which data has been stored in the memory 110. For example, the segmentation unit 103 may segment data starting from data in the front-most position among the entire image, thus creating snapshot images. That is, the segmentation unit 103 segments the first data 210 of 24 KB from the entire image to create a first snapshot image 220. Afterwards, the segmentation unit 103 segments 24 KB of the 32 KB of the second data 211 from the entire image to create a second snapshot image 221, and segments the remaining part (8 KB) of the second data 211 and the third data 212 of 16 KB from the entire image to create a third snapshot image 222.

The loading priority deciding unit 104 may decide data loading priority of the first, second and third data 210, 211 and 212 stored in the memory 110. For example, the data loading priority may be in the order of: the second data 211→the third data 212→the first data 210.

The loading priority deciding unit 104 may decide snapshot image loading priority of the first, second, and third snapshot images 220, 221 and 222 based on the decided data loading priority. For example, the loading priority deciding unit 104 may decide snapshot image loading priority of the first, second, and third snapshot images 220, 221, and 222 such that the second snapshot image 221 including the second data 211 is loaded, the third snapshot image 222 including a part of the second data 211 and the third data 212 is loaded afterwards, and the first snapshot image 200 including the first data 210 is loaded after loading the third snapshot image 222.

The storing/loading controller 105 may store information about the snapshot data loading priority and the first, second and third snapshot images 220, 221, and 222 in the storage 120.

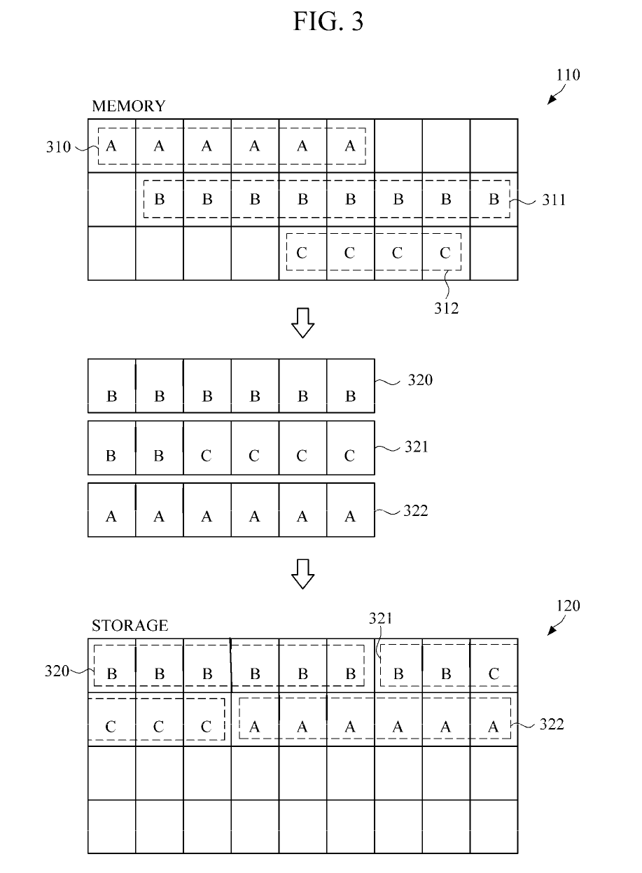

FIG. 3 is an illustration to explain another example of a method in which data and an image are stored in a memory and storage.

Referring to FIGS. 1 and 3, according to an example, it is assumed that the size of data assignable to a memory address is 4 KB, and first data 310 of 24 KB, second data 311 of 32 KB, and third data 312 of 16 KB are stored in the memory 110.

In this example, it is further assumed that the number-of-snapshot images deciding unit 102 decides the number of snapshot images to be 3. Since the entire size of the first, second, and third data 310, 311, and 312 is 72 KB, the size of each snapshot image is determined as 24 KB.

The segmentation unit 103 may segment the entire image including the first, second, and third data 310, 311, and 312 stored in the memory 110, by the number of snapshot images, based on data loading priority. For example, if the data loading priority is the order of: the second data 311→the third data 312→the first data 310, the segmentation unit 103 segments 24 KB of 32 KB of the second data 311 having the highest priority from the entire image to create a first snapshot image 320. Afterwards, the segmentation unit 103 segments the remaining part 8 KB of the second data 311 and the third data 312 of 16 KB from the entire image to create a second snapshot image 321. Afterwards, the segmentation unit 103 segments the first data 310 of 24 KB from the entire image to create a third snapshot image 322.

The loading priority deciding unit 104 may decide data loading priority of the first, second, and third data 310, 311, and 312 stored in the memory 110. For example, the data loading priority may be in the order of: the second data 311→the third data 312→the first data 310.

The loading priority deciding unit 104 may decide snapshot image loading priority of the segmented snapshot images 320, 321, and 322 based on the data loading priority. For example, the loading priority deciding unit 104 may decide the snapshot image loading priority such that the first, second, and third snapshot images 320, 321, and 322 are loaded in the order of: the first snapshot image 320→the second snapshot image 321→the third snapshot image 322.

The storing/loading controller 105 may store information about the snapshot image loading priority and the snapshot images 320, 321, and 322 in the storage 120.

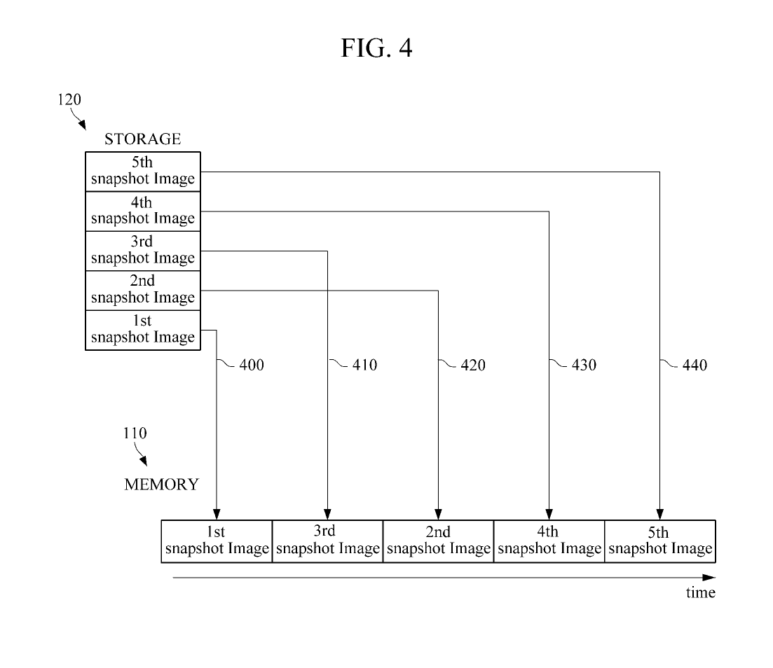

FIG. 4 is an illustration to explain an example of a method of loading snapshot images stored in the storage 120 to the memory 110.

Referring to FIGS. 1 and 4, the storage 120 stores first through fifth snapshot images. In this example, it is assumed that the snapshot image loading priority is in the order of: the first snapshot image→the third snapshot image→the second snapshot image→the fourth snapshot image→the fifth snapshot image. The storing/loading controller 105 may load the first through fifth snapshot images stored in the storage 120 to the memory 110 according to the snapshot image loading priority. Also, the storing/loading controller 105 may load snapshot images stored in the storage 120 to the memory 110 at predetermined time intervals. For example, the storing/loading controller 105 loads the first snapshot image stored in the storage 120 to the memory 110 according to the snapshot image loading priority (400). Then, after a predetermined time interval elapses, the storing/loading controller 105 loads the third snapshot image stored in the storage 120 to the memory 110 (410). Again, after a predetermined time interval elapses, the storing/loading controller 105 loads the second snapshot image stored in the storage 120 to the memory 110 (420). Afterwards, the storing/loading controller 105 loads the fourth snapshot image stored in the storage 120 to the memory 110 (430) after a predetermined time interval elapses. Finally, after a predetermined time interval elapses, the storing/loading controller 105 loads the fifth snapshot image stored in the storage 120 to the memory 110 (440).

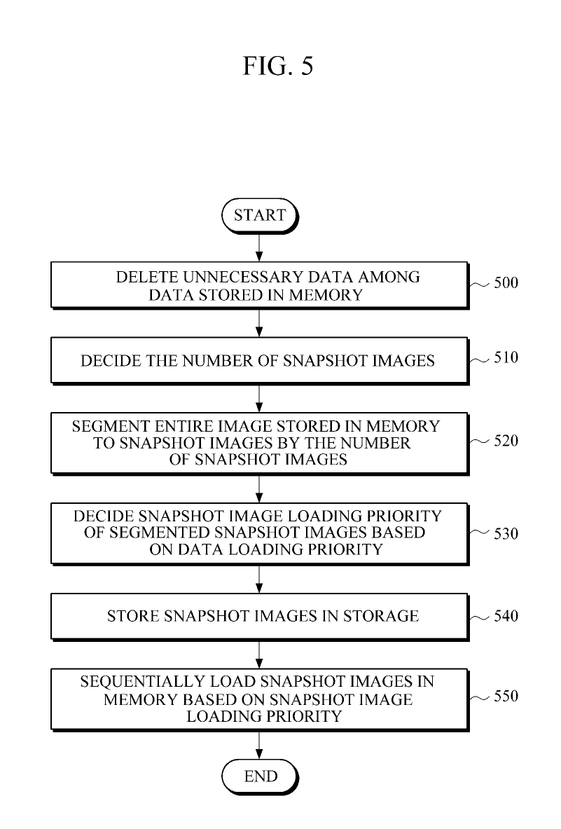

FIG. 5 illustrates an example of a snapshot image segmentation method. As an example, the method may be carried out by a snapshot image segmentation apparatus consistent with FIG. 1.

Referring to FIG. 5, in response to a signal to execute a snapshot function being received, data that does not need to be restored or is not subject of restoration, among data stored in a memory, is deleted (500).

The number of snapshot images is decided (510). For example, the number of snapshot images may be decided based on the size of an entire image stored in the memory, data input/output speed, and a target booting time.

The entire image is segmented by the decided number of snapshot images (520).

The snapshot image loading priority of the segmented snapshot images is decided based on data loading priority of data stored in the memory (530).

Then, the segmented snapshot images are stored in a storage (540).

In response to a signal to restore data being received, the snapshot images stored in the storage are loaded, according to an aspect, sequentially, to the memory (550).

The processes, functions, methods and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

According to certain example(s) described above, according to an aspect, there is provided a technique to reduce time consumed to load snapshot images and restore data.

According to certain example(s) described above, according to an aspect, there is provided a snapshot image segmentation apparatus that decides the size of a snapshot image based on a data input/output speed and restores data in a unit corresponding to the decided snapshot image size. Accordingly, time consumed to restore the data may be reduced when compared to, for example, restoring a snapshot image of a relatively large size at once.

According to certain example(s) described above, according to an aspect, there is also provided a snapshot image segmentation apparatus that loads snapshot images according to snapshot image loading priority. Accordingly, data may be restored selectively, for example, restoring data initially or preferentially needed/used for booting.

According to certain example(s) described above, snapshot images may be loaded at predetermined time intervals, for example, when loaded from a storage to a memory. Accordingly, according to an aspect, there is provided a snapshot image segmentation apparatus that loads an image to a memory, and the snapshot image segmentation apparatus loads the image with a size that is optimal for processing at predetermined time intervals. Accordingly, it may be possible to reduce time consumed for data restoration.

According to certain example(s) described above, according to an aspect, there is provided a snapshot image segmentation method in which the size of a snapshot image is decided based on a data input/output speed, and data is restored in a unit corresponding to the decided snapshot image size. In the method, snapshot images may be according to snapshot image loading priority.

A snapshot image segmentation apparatus, an apparatus to restore data, and teachings provided herein may be incorporated into an electronic device, for example, mobile devices such as a cellular/smart phone, a personal digital assistant (PDA), a portable game console, a portable/personal multimedia player (PMP), a handheld e-book, a portable lab-top/tablet PC, and devices such as a desktop PC, a digital/smart television, a setup box, and the like.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A snapshot image segmentation apparatus comprising:
a number-of-snapshot images deciding unit configured to decide the number of snapshot images;
a segmentation unit configured to segment an entire image including data stored in a memory into one or more snapshot images, based on the number of snapshot images; and
a loading priority deciding unit configured to decide snapshot image loading priority of the segmented snapshot images, based on data loading priority of the data stored in the memory.

2. The snapshot image segmentation apparatus of claim 1, further comprising a storing/loading controller configured to store the segmented snapshot images in a storage.

3. The snapshot image segmentation apparatus of claim 1, further comprising a storing/loading controller configured to load the segmented snapshot images stored in a storage to the memory, based on the snapshot image loading priority.

4. The snapshot image segmentation apparatus of claim 1, wherein the loading priority deciding unit decides the data loading priority based on a booting sequence, frequency of pagefault occurrence, a memory set size, or a combination thereof.

5. The snapshot image segmentation apparatus of claim 1, wherein the number-of-snapshot images deciding unit decides the number of snapshot images based on a size of the entire image stored in the memory, a data input/output speed, and a target booting time.

6. The snapshot image segmentation apparatus of claim 5, wherein the data input/output speed is speed at which data is input/output between a storage and the memory.

7. The snapshot image segmentation apparatus of claim 1, wherein the segmentation unit segments the entire image based on source (SRC) addresses and information about a data size.

8. The snapshot image segmentation apparatus of claim 1, further comprising a deletion unit configured to delete data that is not subject of restoration, among the data stored in the memory.

9. A snapshot image segmentation method comprising:
deciding the number of snapshot images;
segmenting an entire image including data stored in a memory into one or more snapshot images, based on the number of snapshot images; and
deciding snapshot image loading priority of the segmented snapshot images, based on data loading priority of the data stored in the memory.

10. The snapshot image segmentation method of claim 9, further comprising storing the segmented snapshot images in a storage.

11. The snapshot image segmentation method of claim 9, further comprising loading the segmented snapshot images stored in a storage to the memory, based on the snapshot image loading priority.

12. The snapshot image segmentation method of claim 9, wherein the deciding of the snapshot image loading priority comprises deciding the data loading priority based on a booting sequence, frequency of pagefault occurrence, a memory set size, or a combination thereof.

13. The snapshot image segmentation method of claim 9, wherein the deciding of the number of snapshot images comprises deciding the number of snapshot images based on a size of the entire image stored in the memory, a data input/output speed, and a target booting time.

14. The snapshot image segmentation method of claim 13, wherein the data input/output speed is speed at which data is input/output between a storage and the memory.

15. The snapshot image segmentation method of claim 9, wherein the segmenting of the entire image comprises segmenting the entire image based on source (SRC) addresses and information about a data size.

16. The snapshot image segmentation method of claim 9, further comprising deleting data that is not subject of restoration, among the data stored in the memory.

17. An apparatus to restore data using a snapshot function, the apparatus comprising a snapshot image processor configured to create snapshot images from an entire image based on a predetermined number, and load the snapshot images based on data loading priority of data stored in a memory.

18. The apparatus of claim 17, wherein the snapshot image processor comprises:
a segmentation unit configured to segment the entire image into the snapshot images, based on the predetermined number having a relationship to a size of the entire image, a data input/output speed, a target booting time, or a combination thereof; and
a storing/loading controller configured to load the snapshot images to the memory based on predetermined time intervals.

19. The apparatus of claim 17, wherein the snapshot image processor creates a snapshot image having a predetermined size that is based on a data input/output speed and restores the data in a unit corresponding to the predetermined size of the snapshot image.

20. The apparatus of claim 17, wherein the data loading priority is based on a booting sequence, frequency of pagefualt occurrence, a memory set size, or a combination thereof.
